(19) United States
(12) Patent Application Publication
(10) Pub. No.: US 2009/0226024 A1
(43) Pub. Date: Sep. 10, 2009

(54) SPEAKER ENCLOSURE AND HEADPHONE

(76) Inventor: Thomas M. DEAN, Hiram, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/365,571

(22) Filed: Feb. 4, 2009

Related U.S. Application Data
(60) Provisional application No. 61/025,985, filed on Feb. 4, 2008.

(51) Int. Cl. H04R 1/00

(52) U.S. Cl. 381/379

(57) ABSTRACT

An improved audio headphone device that securely places and suspends an audio output device or transducer at or about a person's ear for a personal listening experience, and that provides a comfortable fit regardless of a person's ear type, and that delivers rich sound across the full spectrum of low and high frequencies

### CROSS-REFERENCE TO RELATED APPLICATIONS

This application claims the benefit of U.S. Provisional Patent Application Ser. No. 61/025,985 filed Feb. 4, 2008, the entirety of which is hereby incorporated herein by reference for all purposes.

### TECHNICAL FIELD

The present invention relates generally to the field of audio headphones and earbud type audio speakers.

### BACKGROUND

Three design objectives are proposed as desirable to a successful headphone design:
An unobtrusive means of securely delivering an audio signal to a wearer's ear,
A comfortable custom fit for a wearer regardless of ear type, and
Delivery of the highest fidelity audio signal possible.

In every known example of headphone design, one or more of these objectives tends to be sacrificed at the expense of another. There have existed up until recently four basic headphones types:
Circum-aural,
Supra-aural,
Earbud
In-ear or Canal phones.

A careful review of the development of each these headphone types shows that there remains a need for a headphone device that meets all three fundamental objectives restated as follows:
Securely but unobtrusively place and suspend an audio output device or transducer at or about a person's ear to create a personal acoustical space or listening environment whereby the device is almost imperceptible to the wearer;
Provide a customizable comfortable fit regardless of a person's ear type;
Deliver rich sound across the full spectrum of low and high frequencies.

There remains room for further advancement in the areas of secure fit, universal comfort and improved acoustics. Thus, it is to the provision of an improved audio device addressing these three areas that the present invention is directed.

### SUMMARY OF THE INVENTION

In example forms of the invention, an improved audio device provides secure fit, universal comfort, and improved acoustics. In one aspect, the audio device is a universal fit audio headphone device including a body member having an arcuate profile for positioning adjacent an ear of a wearer, a heel member adjustably coupled to the body member by a first jointed connection allowing at least one degree of rotational freedom, and a speaker enclosure frame adjustably coupled to the body member by a second jointed connection allowing at least one degree of rotational freedom.

In another aspect, the audio device includes a first soft-bodied component, a second soft-bodied component; and a coupling between the first soft-bodied component and the second soft-bodied component, the coupling providing at least one degree of freedom of movement between the first soft-bodied component and the second soft-bodied component.

In still another aspect, the audio device includes a body member for positioning adjacent an ear of a wearer, the body member having a pinna pad receiver opening formed therein. The audio device also includes a heel member coupled to the body member by a first jointed coupling allowing at least one degree of rotational freedom therebetween, and a speaker enclosure frame coupled to the body member by a second jointed coupling allowing at least one degree of rotational freedom therebetween. The audio device also includes an earbud receiver repositionably mounted within the speaker enclosure frame, and at least one interchangeable pinna pad for removable engagement within the pinna pad receiver opening of the body member.

An audio headphone device according to one form of the present invention includes a soft body construction with no metal or hard plastic parts. Otherwise described, the audio headphone device comprises compressible and collapsible components. Optionally, left-ear and right-ear headphone devices according to the invention comprise common or shared component parts that can be used to assemble both left-ear and right-ear devices and thereby reduce tooling costs by as much as 50%.

An audio headphone device according to the invention includes parts assembled using only compression fit or snap together techniques, whereby no glue or conventional metal fasteners are required. An audio headphone device according to the invention includes a loop/heel contour combined with selected surfaces of high coefficient of friction to provide a passive support and stabilization system for secure and comfortable placement on the ear, wherein no biasing or pinching means are employed to provide secure comfortable placement. An audio headphone device according to the invention includes interchangeable/reversible pinna pads and heel pads to provide unlimited fit range among consumers having ears of differing anatomical structures as compared with other consumers or a consumer having one ear of one structure and the other ear of another structure.

A headphone device according to example forms of the invention includes seven points of adjustment to accommodate unlimited fit range among consumers having ears of differing anatomical structures as compared with other consumers or a consumer having one ear of one structure and the other ear of another structure. In alternate forms, a headphone device according to the invention includes up to seven points of adjustment, or more than seven points of adjustment are provided.

In example forms, an audio headphone device according to the invention includes a headphone loop molded using a resilient material providing an un-jointed non-binding range of flexible extension for use in placement about the contour profile of the backside of the pinna.

In example forms, an audio headphone device according to the invention includes a headphone loop comprising two soft bodied parts, i.e., a loop and a heel possessing both tilt and rotational adjustment means therebetween.

In example forms, an audio headphone device according to the invention includes a heel adjustment means providing a full range of motion within its limits. In alternate embodiments, a heel attachment means providing incremental range of motion within its limits is provided.

In example forms, an audio headphone device according to the invention includes a soft bodied attachment means of mating the loop to a speaker enclosure frame. In alternate embodiments, a soft bodied orbital attachment means of mating the loop to a speaker enclosure frame is provided, whereby the speaker enclosure frame is able to rotate about the attachment means for orienting the sound source depending on wearer's ear structure or to adjust the location from which sound is emitted to the wearer's ear. In other embodiments, an audio headphone device includes a speaker enclosure assembly that is free to rotate within the speaker enclosure frame and travel freely up and down within a slot of the frame to adjust the speaker enclosure height to the wearer's ear structure or to adjust the location from which sound is emitted to the wearer's ear.

In example forms, an audio headphone device according to the invention includes a speaker enclosure frame possessing one or more acoustical surfaces to provide limited isolation from ambient sounds while directing forward producing sound waves from an earbud speaker or sound emitting source toward the wearer's ear. In alternate embodiments, an audio headphone device includes a speaker enclosure assembly comprised of interchangeable collapsible and or compressible outer and inner shells that is sandwiched against a speaker enclosure frame.

In example forms, an audio headphone device includes interchangeable outer and inner speaker enclosure shells of various shapes possessing varied acoustical surfaces. In alternate embodiments, an audio headphone device includes an interchangeable outer speaker enclosure shell sandwiched against the frame that comprises an earbud receiver. In other embodiments, an audio headphone device includes a soft membrane bud cap used to redirect back pressure sound waves from earbud speakers. In other embodiments, an audio headphone device includes a soft membrane bud cap combined with an interchangeable collapsible outer speaker enclosure shell creating an acoustic chamber for back pressure sound waves.

In example forms, an audio headphone device includes an audio headphone device comprising a soft membrane bud cap combined with an interchangeable outer speaker enclosure shell sandwiched against the frame and generally possessing an acoustical horn emission port to emit back pressure sound waves. In other embodiments, an audio headphone device includes a soft membrane bud cap combined with an interchangeable outer speaker enclosure shell sandwiched against the frame having no outlet and creating a sealed speaker enclosure using an earbud as the sound emitting source.

In example forms, an audio headphone device includes a bud receiver with contoured walls providing space within which an earbud may be angled within the receiver. In other embodiments, an audio headphone device includes a wired headphone device of the present invention with a transducer manufactured or assembled with the device and sold as a complete headphone. In alternate embodiments, an audio headphone device includes a wireless headphone device of the present invention with a transducer manufactured or assembled with the device, which includes batteries, a transmitting device and a receiver and sold as a complete headphone.

These and other aspects, features and embodiments of the invention will be understood with reference to the drawing figures and description herein.

### DESCRIPTION OF THE DRAWINGS

FIG. 1 is a perspective view of an example form of audio earbud carriers according to the present invention.

FIGS. 2A-2C show side, front and back views of an example form of audio earbud carriers according to the present invention.

FIGS. 3A-3B are exploded views of audio earbud carriers according to the present invention disclosing two embodiments of the loop attachment and bud cap.

FIG. 4A is an enlarged isolated cross section of the heel portion of an audio earbud carrier.

FIGS. 4B-4C illustrate alternative heel attachment methods.

FIG. 5 is an enlarged detail view of loop attachment methods.

FIGS. 6A-6B are enlarged detail views of two speaker enclosure assembly embodiments.

FIG. 7 is an anatomical side view of a typical human ear.

FIG. 8 is a transverse cross sectional view of a typical human ear illustrating the ear canal and cartilage of the outer ear.

FIG. 9 is a side view diagram illustrating a passive support and stabilization system for placement of a device of the present invention about and around the ear without the use of a biasing means.

FIG. 10 is a backside diagram illustrating a passive support and stabilization system for placement of a device of the present invention about and around the ear without the use of a biasing means.

FIGS. 11A, 11B, 12A, 12B illustrate prior art devices that demonstrate collapsible or compressible features when a compression force is applied to the device which dampens the compression force to the cartilage of the outer ear.

FIGS. 13A, 13B illustrate a device of the present invention that demonstrates collapsible and compressible features when a compression force is applied to the device which dampens the compression force to the cartilage of the outer ear.

FIG. 14 illustrates the overall pliability and compression features of the present invention.

FIG. 15 is a chart outlining the typical steps employed for optimal placement and adjustment of a device of the present invention onto and about a wearer's ear.

FIG. 16 illustrates three anatomical variations of the outer ear pinna.

FIG. 17 demonstrates step 1 and 3 of the fit chart of FIG. 15 and illustrates interchangeable pinna ear pads in a variety of shapes used for selection and optimal fit depending on the anatomical structure of a wearer's pinna as illustrated in FIG. 16.

FIG. 18A, 18B illustrate a reversible pinna pad in both positions.

FIG. 19A, 19B illustrate an alternative means to install a reversible pinna pad in a device of the present invention.

FIG. 20 demonstrates step 2 of the fit chart of FIG. 15.

FIGS. 21A-21C demonstrates step 4 of the fit chart of FIG. 15.

FIGS. 22A-22B demonstrates step 5 of the fit chart of FIG. 15.

FIGS. 23A-23F demonstrate examples of a variety of ear shapes and the corresponding fit profile required of a device to provide optimal fit and comfort.

FIG. 23G illustrates the overlapping fit profiles for the ears of FIGS. 23A-23F.

FIG. 24 illustrates a device of the present invention which employs a bud cap for the redirection of back pressure sound waves generated by an earbud.

FIG. 25 illustrates a device of the present invention with the bud cap exploded.

FIG. 26 illustrates a device of the present invention with both the bud cap and ear bud exploded.

FIG. 27 demonstrates an inside view of a device of the present invention illustrating acoustic features of the speaker enclosure.

FIGS. 28A-28E illustrates bud cap detail views.

FIG. 29 is a perspective view of a typical earbud design illustrating the typical direction of forward pressure and back pressure sound waves.

FIG. 30 is a perspective view of a device of the present invention with an installed earbud and bud cap illustrating an acoustical horn contoured emission port defined within the collapsible/compressible bud receiver outer shell for redirected back pressure sound waves.

FIGS. 31 and 32 are side and rear views respectively of a device of the present invention with an installed earbud and bud cap illustrating an acoustical horn contoured emission port defined within the collapsible/compressible bud receiver outer shell for redirected back pressure sound waves.

FIG. 33 is a perspective view of a device of the present invention with an installed earbud and bud cap illustrating a sealed collapsible/compressible speaker enclosure design.

FIGS. 34A-3D illustrates alternative acoustical chamber designs of collapsible/compressible bud receiver outer shells for devices of the present invention.

FIG. 34E illustrates an alternative acoustical chamber design for a collapsible/compressible bud receiver outer shell possessing one or more scalloped regions to reflect ambient sound.

FIG. 35 is a prior art view illustrating the possible angle adjustments of an earbud within the bud receiver of the present invention.

FIG. 36 illustrates an alternative design of the present invention which employs a wired transducer manufactured within the device.

FIG. 37 illustrates a wireless version of the present invention.

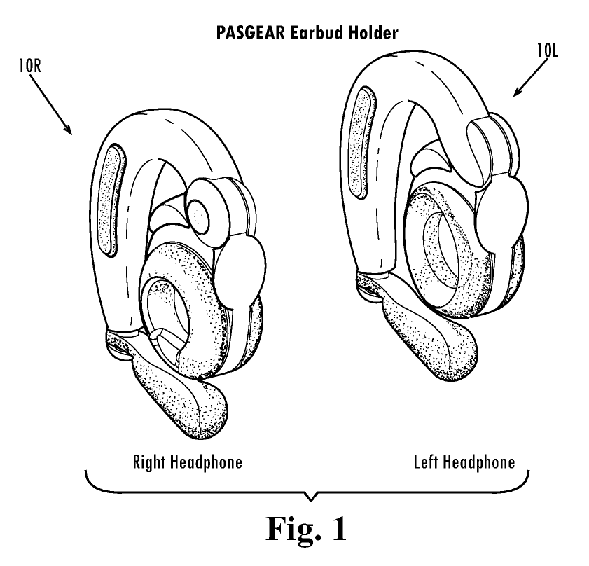

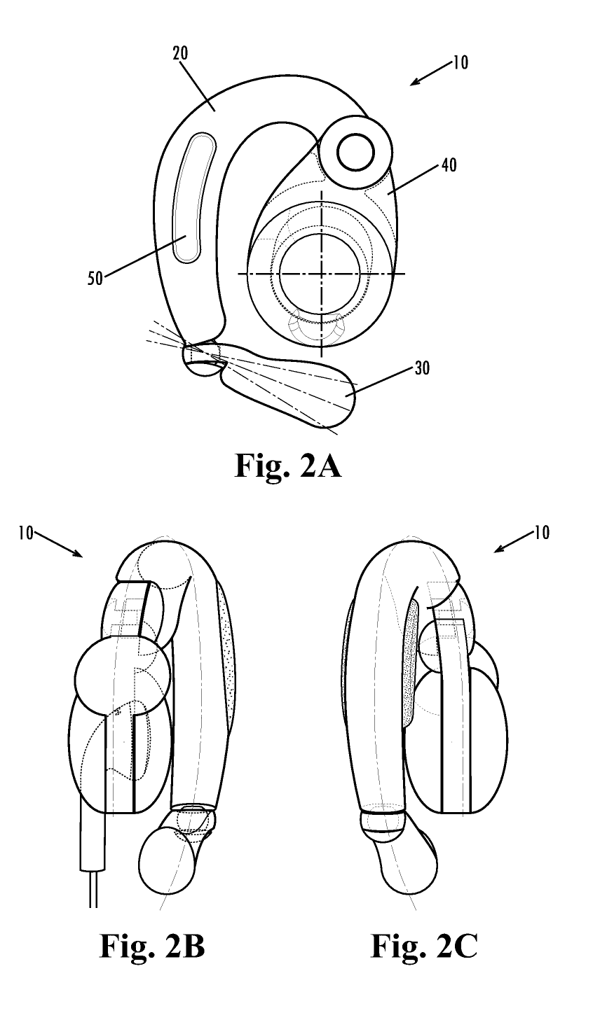

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

A new hybrid headphone type now exists (as shown and described in International Patent Application PCT/US2007/062127, incorporated herein by reference) that begins to address these three objectives collectively in one or more embodiments, first by placing the audio output device over an auditory canal entrance of the ear without compression against or into the ear. Second, the materials employed and the manner in which they are employed within a particular embodiment play key roles in improvements in secure fit, universal comfort and acoustics. This collective approach to superior headphone design is now being termed and trademarked as PASGEAR™ for Passive Acoustic Support Gear. U.S. Provisional Patent Application No. 60/773,258 (filed 14 Feb. 2006), U.S. Provisional Patent Application No. 60/789,870 (filed 6 Apr. 2006), and U.S. Provisional Patent Application No. 60/862,484 (filed 23 Oct. 2006), all incorporated by reference herein and in copending International Patent Application PCT/US2007/062127, identify advancements in headphone design unlike the previously known headphone types of the prior art.

### Secure Fit:

With regard to secure fit, all known prior art employ devices or means that relies on spring-type mechanisms to bias the speaker enclosure against a person's ear. Some devices effectively are secured by a pinching means of some sort. While these devices may be an effective securing means, they generally greatly diminish the level of comfort for the user. Some earbud devices now incorporate a thin clip or loop that provide a marginal level of security to some users but remain undesirable to those who disfavor earbuds.

### Universal Comfort:

Headphone devices whose claim is comfort typically make the attempt by employing the minimalist approach and provide almost no means for a secure fit. The comfort may be limited to users with the particular ear shapes. Earbuds are one example. They remove all means to secure themselves to your ear except by using your ear as the mounting means. Earbuds are prone to fall out with only minimal activity and many consumers simply disfavor the feel of inserting a device into their ear. Some manufacturers provide multiple sized ear canal adaptors. But earbuds inherently apply stress to the soft and hard tissues of the ear, which can lead to severe pain only after short periods of time for many users.

### Improved Acoustics:

The new hybrid headphone type is generally an open design in that the speaker enclosure generally lacks structures normally employed in other headphone types to isolate outside ambient sound sources. For example, circum-aural headphones completely enclose the ear. Supra-aural effectively encloses the ear by placing foam pads against the entire ear. Earbuds and in-ear canal phones isolate the user from outside ambient sounds by nearly or completely shutting off the ear canal. While these designs may provide for great sound fidelity, they do so at the expense of comfort and in the case of earbuds, a secure fit.

The open design of the hybrid headphone type, in addition to the lack of ambient sound isolation, also allows some sound waves in the lower frequencies to escape, which is exhibited by a drop in the bass response. In certain situations, such cycling or jogging in a racing event, substantial isolation from your surroundings is undesirable and potentially unsafe. Nevertheless, delivering good bass response in addition to quality in the higher frequencies is an advantage of the PASGEAR device of certain example embodiments according to the present invention.

Delivering the kind of bass response desired by many music enthusiasts in a highly portable device has until now been found only in high end, expensive sound isolating and or sound canceling in-ear or canal type headphones. However, many consumers disfavor having to insert an earbud at or into the ear canal. Moreover, there continues to be concern over safety of in-ear devices by claims that they may lead to early noise-induced hearing loss in spite of claims that their sound isolating or canceling features enables users to listen at safer lower volume levels. Volume levels remain the choice of the individual consumer in all but a few currently available products. Moreover, an open design such as the present invention remains superior by effectively not completely isolating you from those ambient sounds that are essential to one's safety in situations such as cycling and anywhere that you should be aware of your surroundings. The ability to hear one's surroundings in an open design headphone is therefore desirable. However, because the invention features interchangeable parts, one embodiment features a part which can be added to provide a level of sound isolation for environments with higher ambient sounds such as in an airplane or public transit system.

In improving any aspect of sound quality in an open design such as in the present invention, it is important to understand how the ear processes sound as it approaches the pinna and travels into the ear canal. To this end, the following information is of note (from Wikipedia):
“The purpose of the pinna is to collect sound. It does so by acting as a funnel, amplifying the sound and directing it to the ear canal. While reflecting from the pinna, sound also goes through a filtering process which adds directional information to the sound (see sound localization, head-related transfer function, pinna notch). The filtering effect of the human pinna preferentially selects sounds in the frequency range of human speech.”
“Amplification of sound by the pinna, tympanic membrane and middle ear cause an increase in level of about 10 to 15 dB in a frequency range of 1.5 kHz to 7 kHz. This amplification is an important factor in inner ear trauma resulting from elevated sound levels.”
“The pinna works differently for low and high frequency sounds. For low frequencies, it behaves similarly to a reflector dish, directing sounds toward the ear canal. For high frequencies, however, its value is more sophisticatedly reckoned. While some of the sounds that enter the ear travel directly to the canal, others reflect off the contours of the pinna first: these enter the ear canal at a very slight delay. Such a delay translates into phase cancellation, where the frequency component whose wave period is twice the delay period is virtually eliminated. Neighboring frequencies are dropped significantly. This is known as the pinna notch, where the pinna creates a notch filtering effect.”

The present invention provides a carrier for retaining an audio output device on or adjacent a user's ear without insertion into the ear canal. The audio output device in the preferred embodiment is one or more transducers preinstalled with the carrier. In another embodiment, the audio output device may be an earbud that the user can interchangeably install into the carrier.

The carrier is preferably formed entirely or substantially entirely of a material or materials such as described in International Patent Application PCT/US2007/062127. The carrier features a unique support and stabilization system enabling a secure fit by means of two passive contact regions along the carrier loop for support and two surfaces that serve to stabilize the device. The device of the present invention provides universal comfort for those with different ear shapes. Example embodiments of the invention provide improved acoustics by means of a closed speaker housing design whose housing is formed from a soft bodied material or membrane. The interior structure of said housing is contoured generally as an acoustical horn to concentrate and direct backward generated sound waves from the back side of the transducer toward the pinna of the ear. In one example embodiment a closed or sealed soft bodied speaker housing membrane acts as a resonance chamber, amplifying lower frequency sound waves. Because the speaker housing is an interchangeable part, the wearer may replace the housing with a housing possessing an alternate acoustic signature or surface contour. Alternate housings serve as low tech equalizers offering the user a variety of acoustic choices.

With reference to example embodiments depicted in the figures, an audio headphone device or earbud speaker carrier 10 includes an arcuate or looped body member 20 having a heel attachment coupling 22 at one end thereof, and a loop attachment coupling 24 at another end thereof. Typically, a mirror-image pair of headphone devices 10R, 10L are provided for use on the wearer's right and left ears.

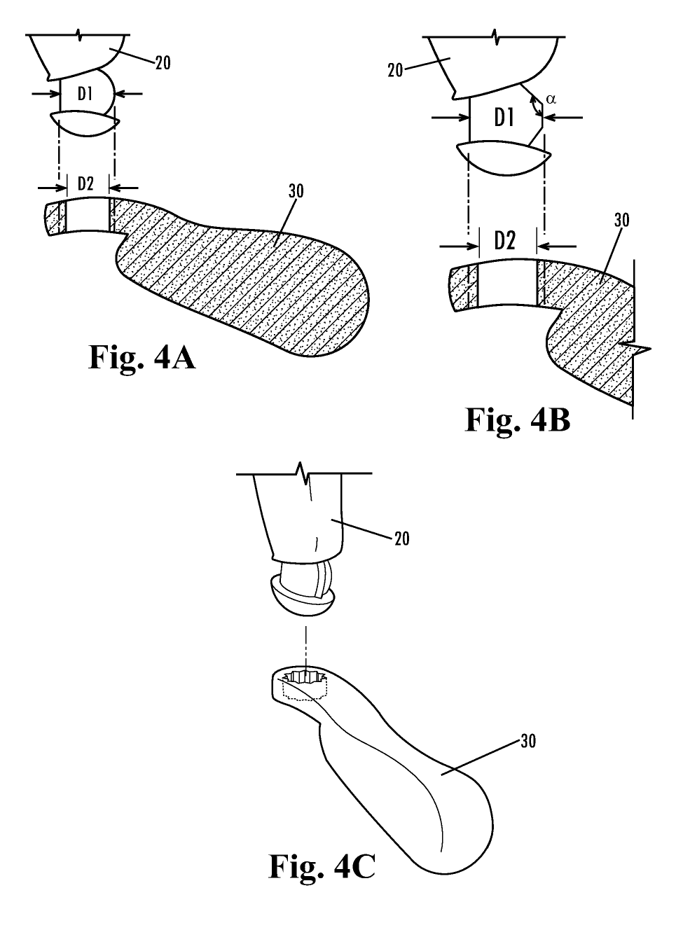

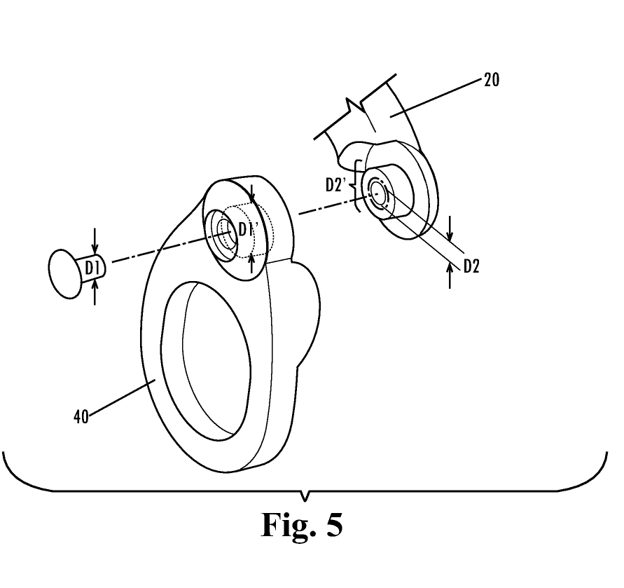

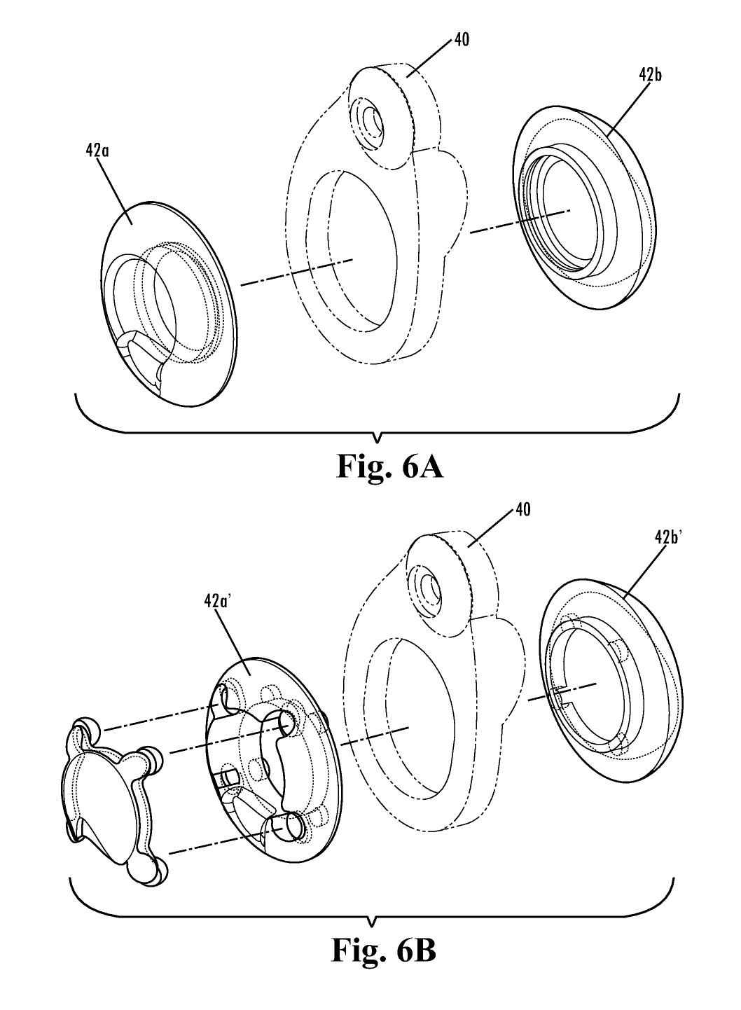

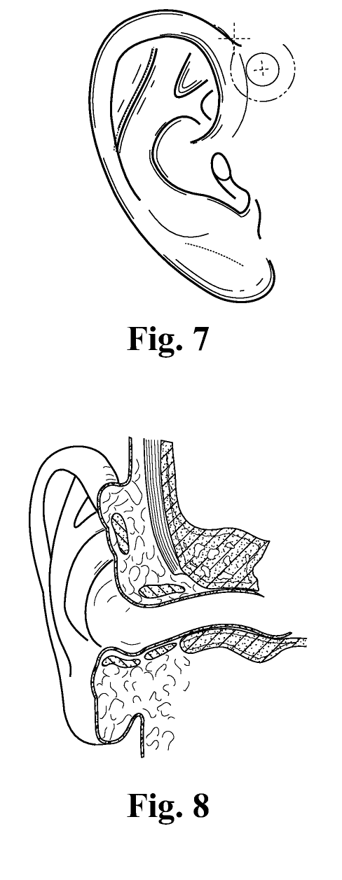

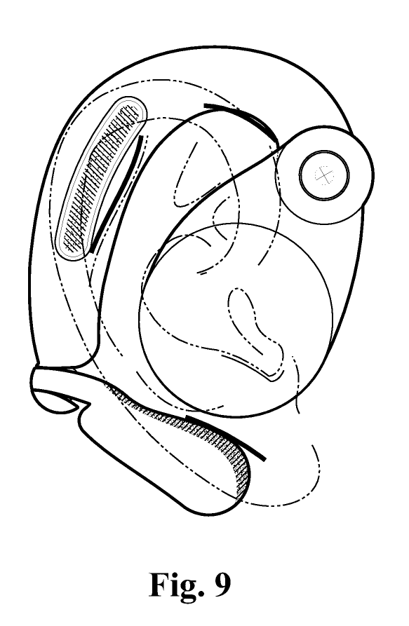

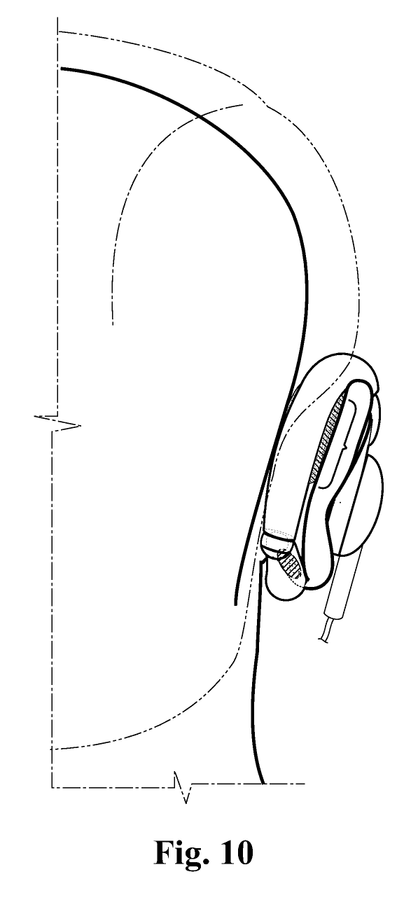

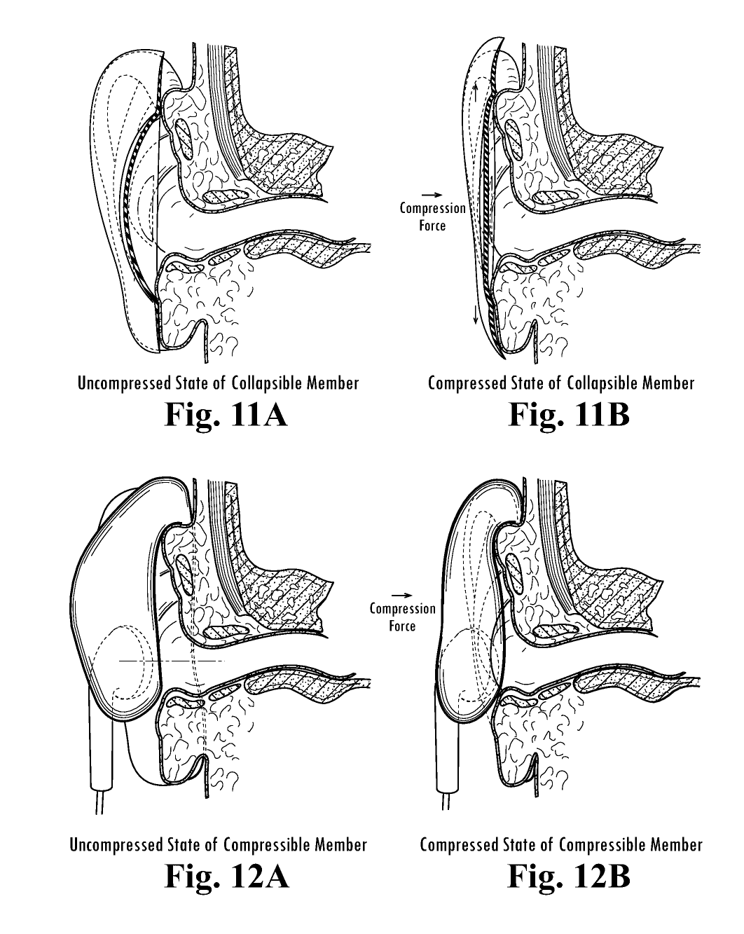

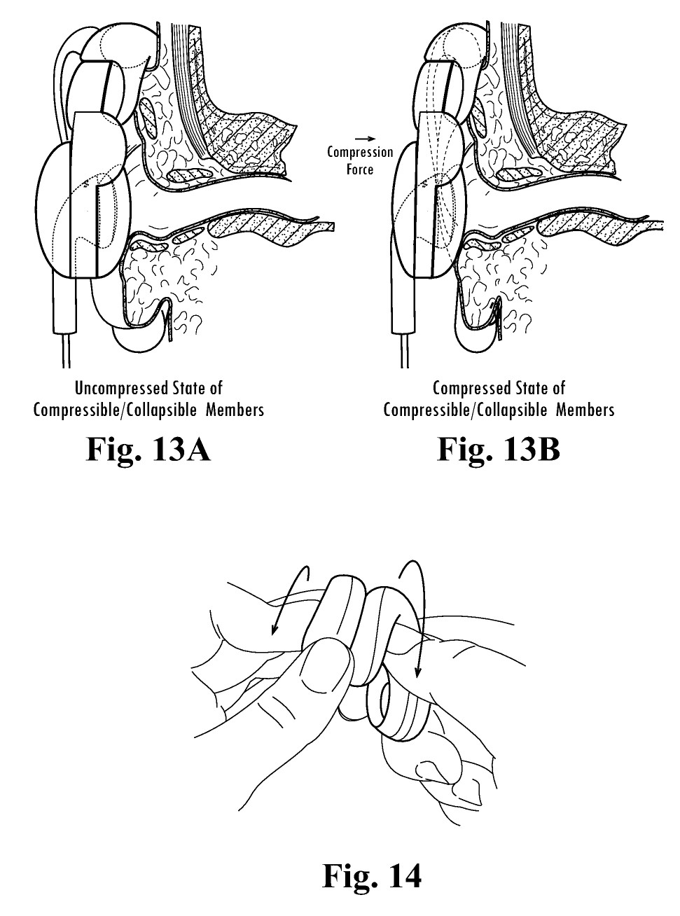

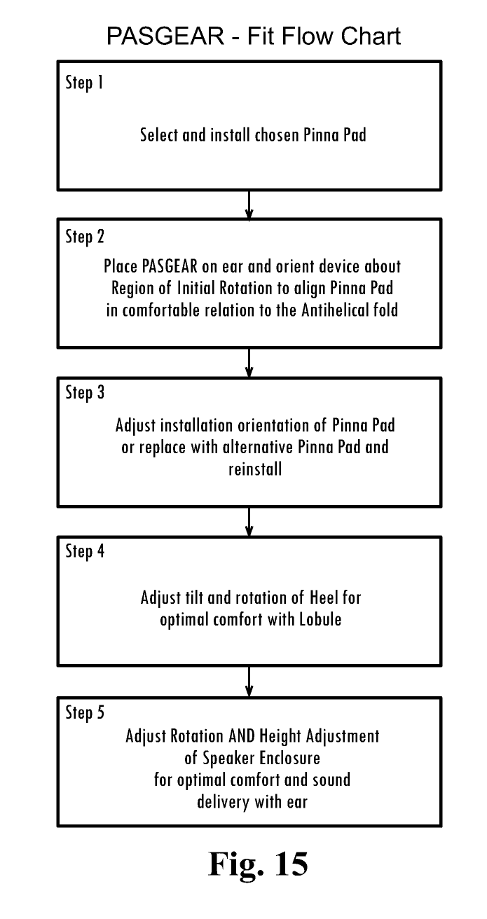

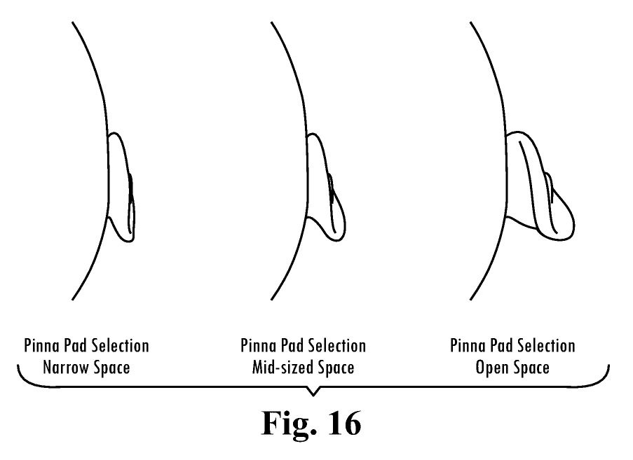

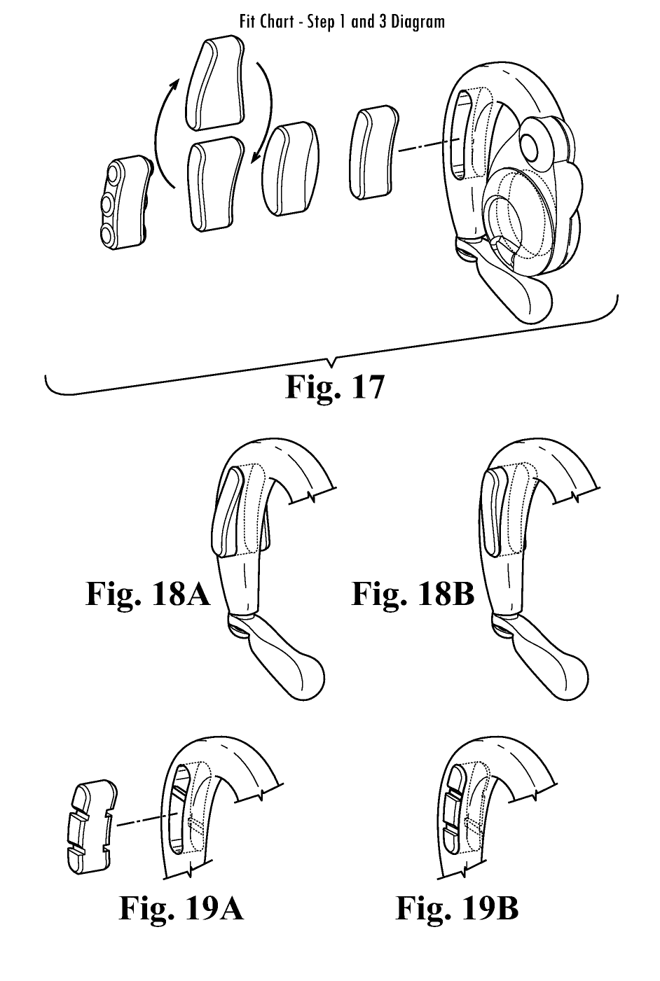

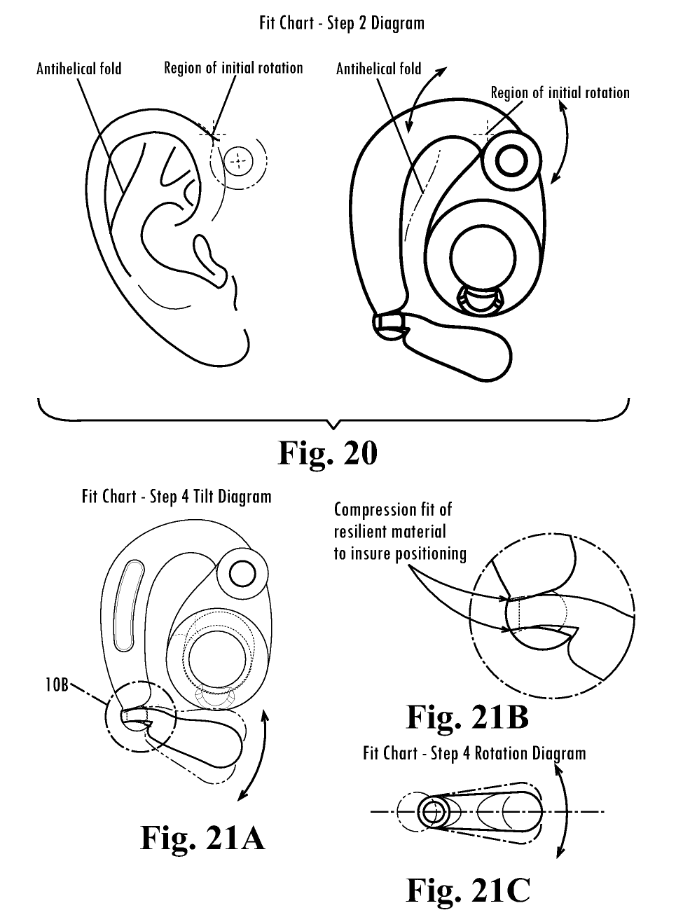

The headphone device 10 further includes a heel member 30 adjustably coupled to the heel attachment coupling 22 of the body member 20. The repositionable heel coupling preferably comprises a ball-and-socket or other type of joint having an interference fit to allow the heel to be adjusted relative to the body member with one, two, or three degrees of rotational freedom upon light manual pressure, but to retain a set position once fit to the wearer's ear. Optionally, two or more differing heel members are provided for interchangeable use, by means of a detachable coupling with the body member, for improved fit and/or comfort. For example, the differing heel members may have different thicknesses, different lengths, different surface textures, different compressibilities, and/or other differing characteristics. Example embodiments of the heel coupling are shown in FIGS. 4A-4C, and positional adjustment is shown according to example form in FIGS. 21A-21C.

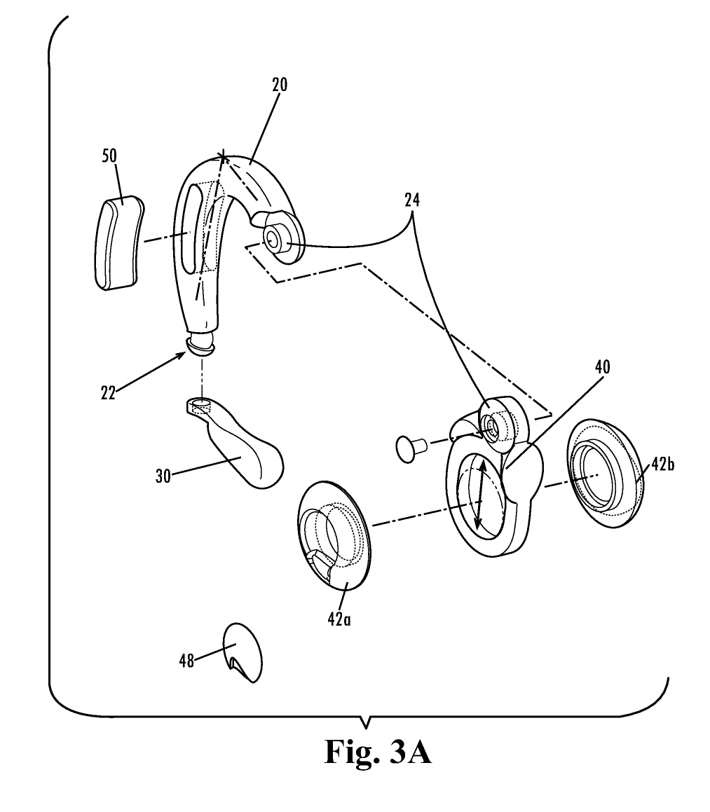

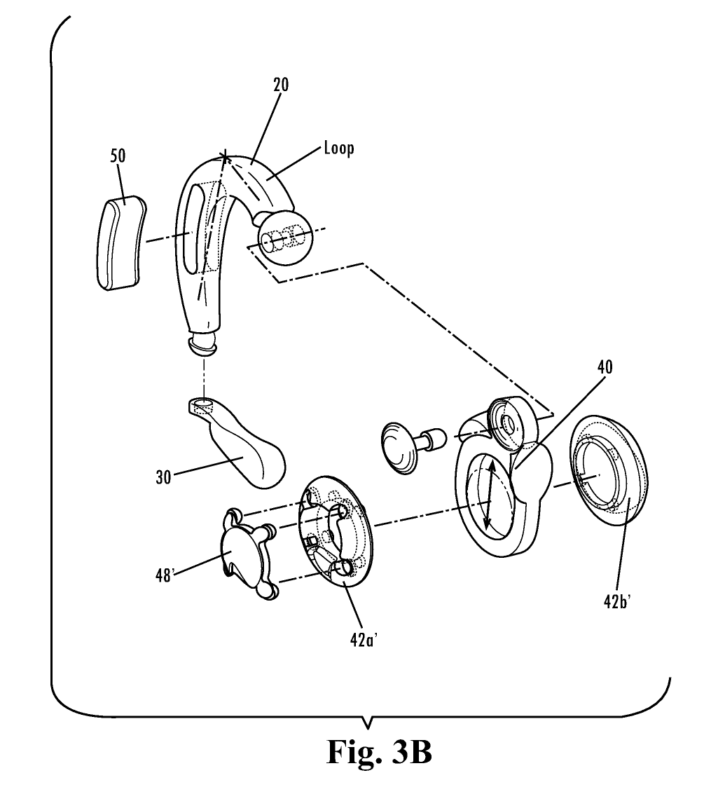

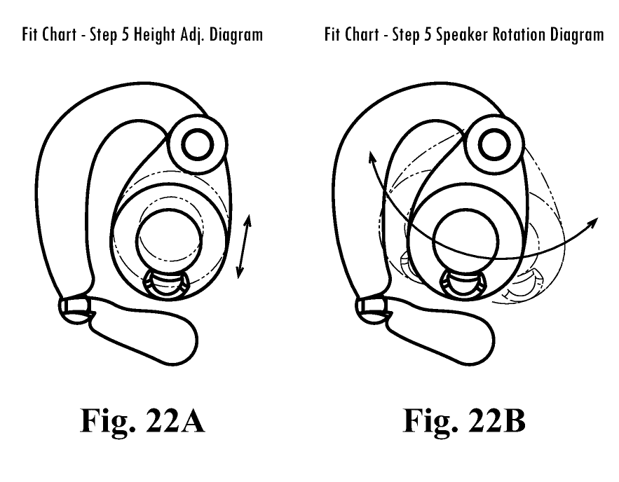

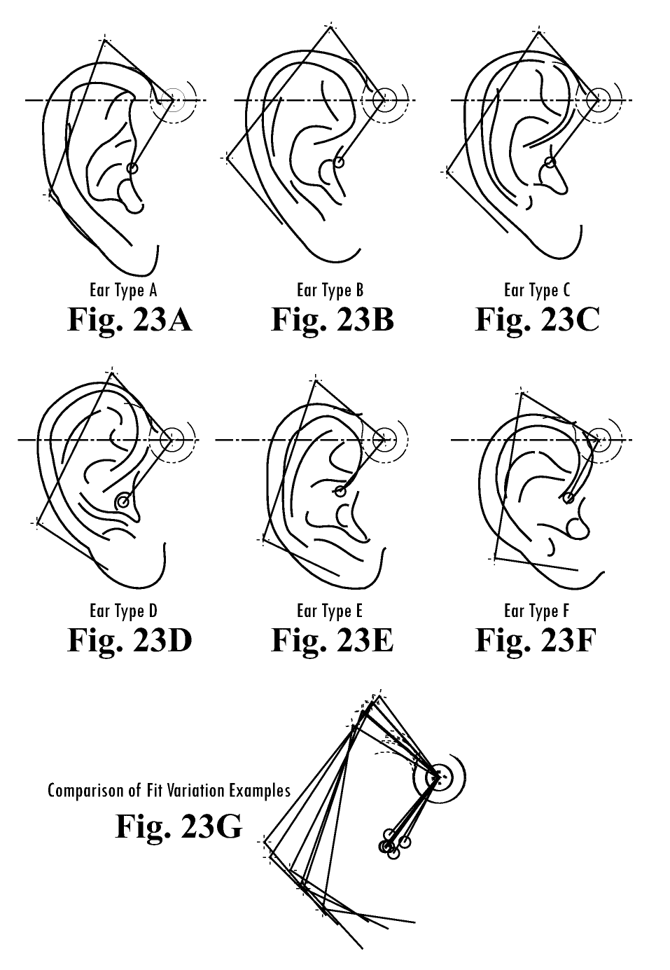

The headphone device 10 further includes a speaker enclosure frame 40 adjustably coupled to the loop attachment 24 of the body member 20. In the embodiment of FIG. 3A, the repositionable loop coupling comprises a hinge or pin joint having an interference fit to allow the speaker enclosure frame to be adjusted relative to the body member with one degree of rotational freedom upon light manual pressure, but retaining a set position once fit to the wearer's ear. In an alternate form shown in FIG. 3B, the repositionable loop coupling preferably comprises an orbital joint having an interference fit to allow the speaker enclosure frame to be adjusted relative to the body member with two or three degrees of rotational freedom upon light manual pressure, but retaining a set position once fit to the wearer's ear. Positional adjustment of the speaker enclosure frame relative to the body member is shown in FIG. 22B.

The headphone device 10 further includes an earbud receiver 42, engaged with the speaker enclosure frame 40, for releasably engaging an audio earbud speaker. The earbud receiver is optionally laterally and/or rotationally repositionable within the speaker enclosure frame by means of a generally circular hub extending between outer and inner receiver halves 42a, 42b when assembled within an oval or oblong channel within the speaker enclosure frame. An interference fit allowing positional adjustment with light manual pressure, but retaining a set position once fit to the wearer is preferably provided between the earbud receiver and the channel of the speaker enclosure frame. Positional adjustment of the earbud receiver relative to the speaker enclosure frame is shown in FIGS. 3 and 22A.

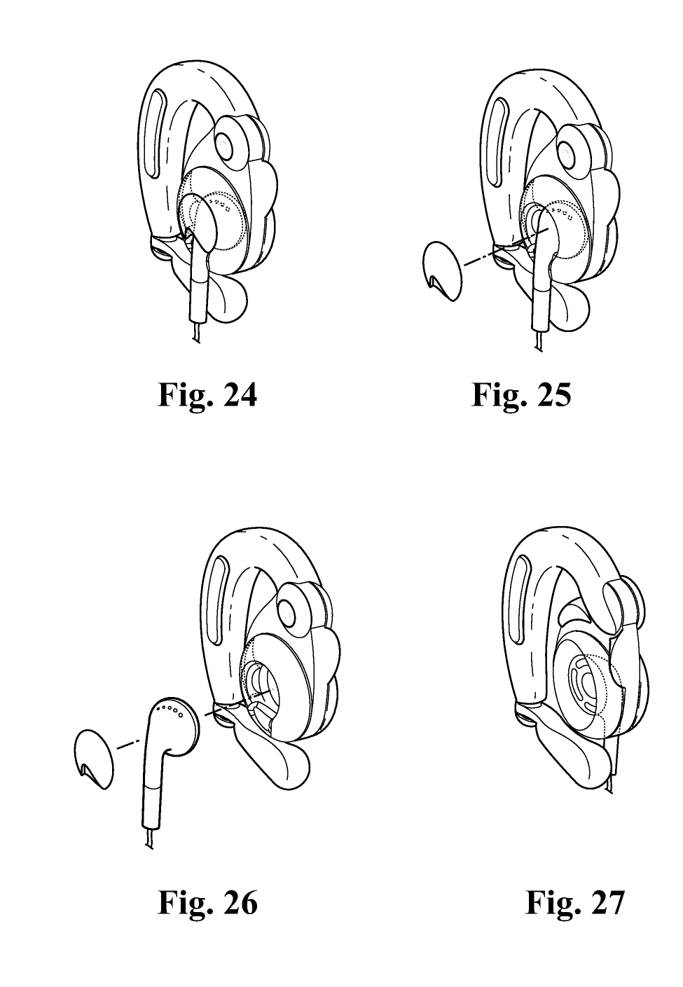

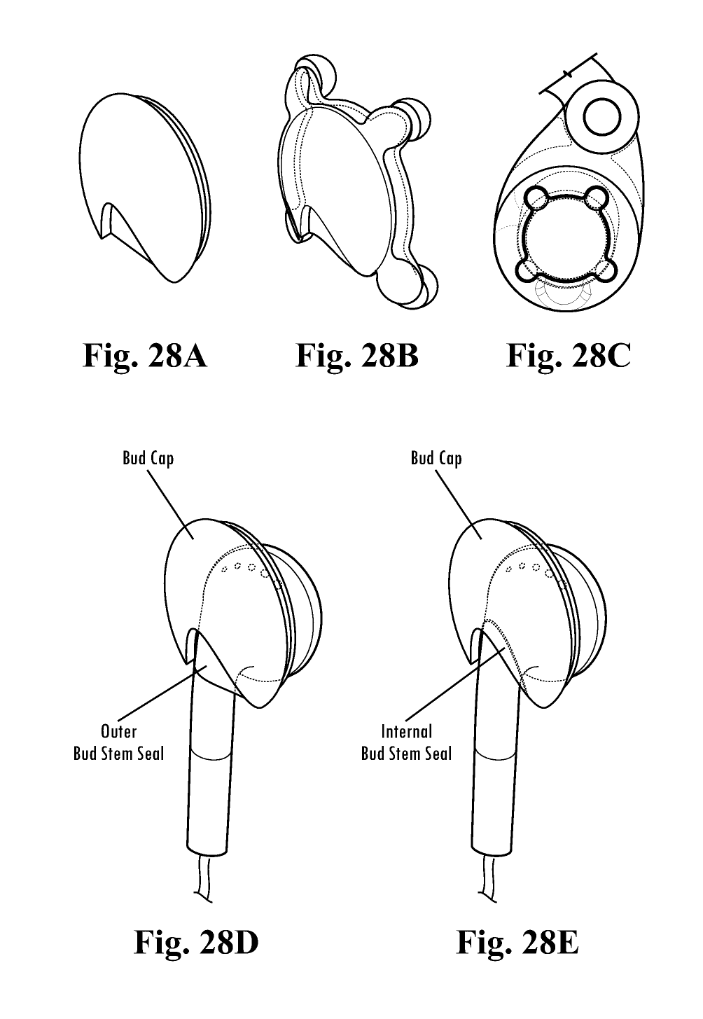

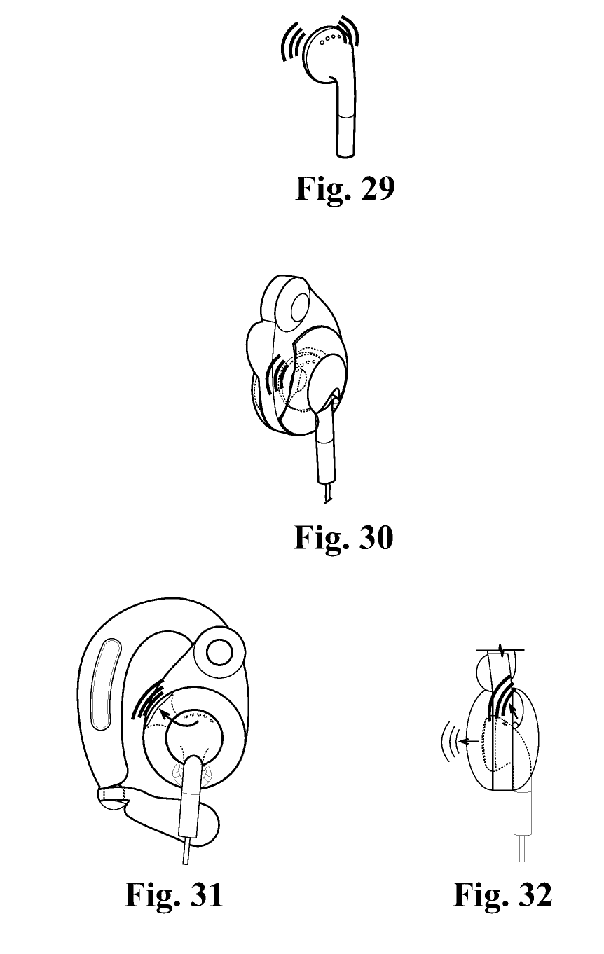

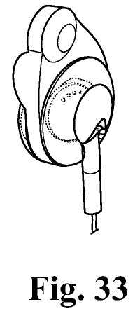

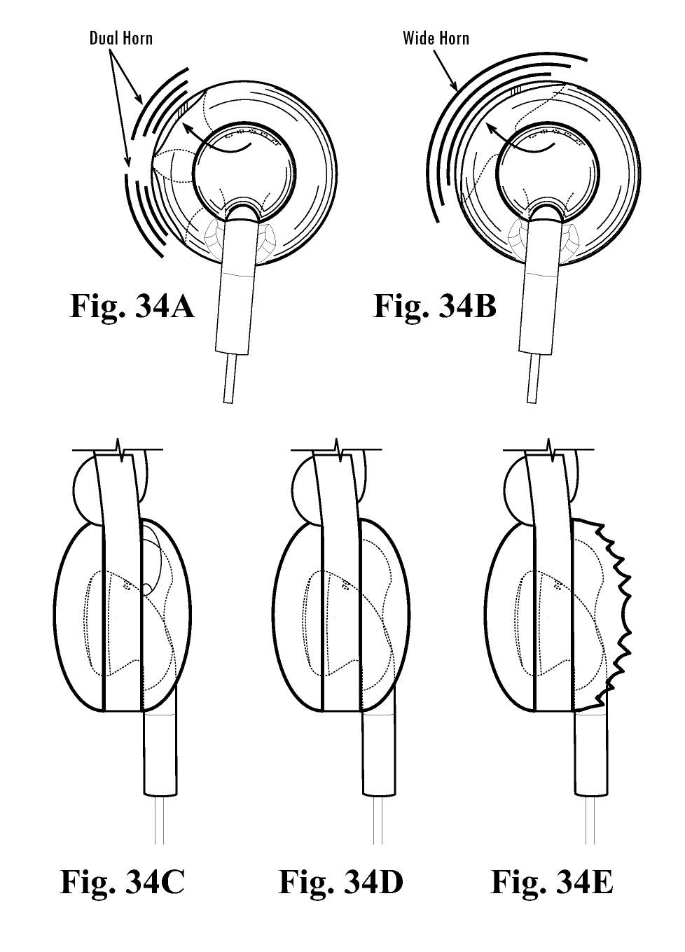

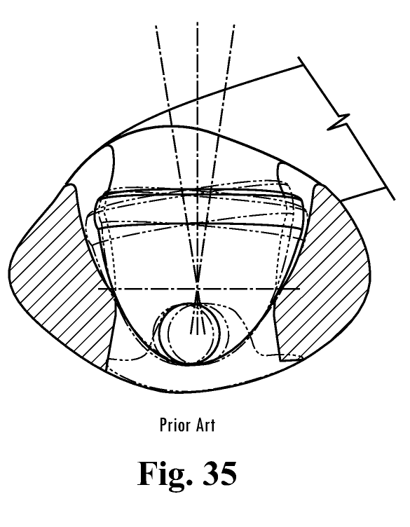

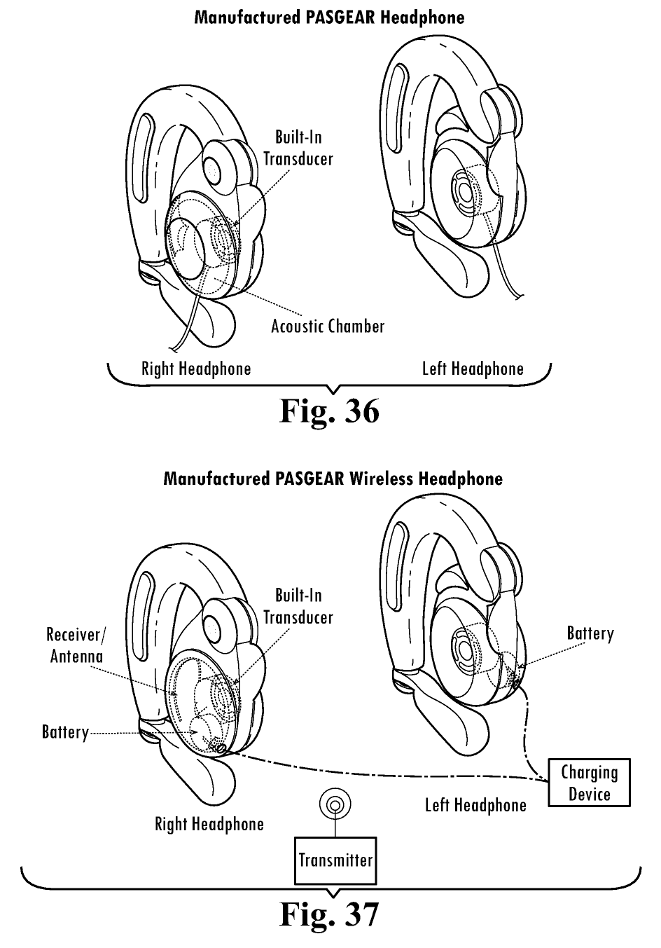

Optionally, two or more interchangeable sets of earbud receivers are provided for accommodating earbud speakers of different configurations, for adjusting fit to the wearer's ear, and/or for aesthetic variation, as shown for example in FIGS. 30-34. In alternate embodiments, a wired or wireless speaker transducer is built into an acoustic chamber in place of the earbud receiver, as shown in FIGS. 36-37. A bud cap 48 is optionally provided over the opening of the outer receiver half 42 after an audio earbud speaker is installed therein, for improved acoustics, as shown in example forms in FIGS. 24-33.

The headphone device 10 further includes a repositionable and/or interchangeable pinna pad 50 received within a chamber or slot formed in the body member 20. As seen with reference to FIGS. 17-19, a two or more pinna pads 50 are optionally provided to allow a variety of fit adjustments. The different pinna pads may vary in configuration in terms of compressibility, shape, thickness, surface coefficient of friction, surface finish or contour, smooth or ribbed variations, symmetric or asymmetric variations, or in other manners. Optionally, one or more of the pinna pad variations is symmetric in profile to permit reversible orientation within the body member, but asymmetric in thickness to vary the fit depending on the orientation.

While the invention has been described with reference to preferred and example embodiments, it will be understood by those skilled in the art that a variety of modifications, additions and deletions are within the scope of the invention, as defined by the following claims.

What is claimed is:

1. A universal fit audio headphone device comprising:
a body member having an arcuate profile for positioning adjacent an ear of a wearer;
a heel member adjustably coupled to the body member by a first jointed connection allowing at least one degree of rotational freedom; and
a speaker enclosure frame adjustably coupled to the body member by a second jointed connection allowing at least one degree of rotational freedom.

2. The universal fit audio headphone device of claim 1, wherein the body member, the heel member, and the speaker enclosure comprise a compressible material of construction.

3. The universal fit audio headphone device of claim 1, wherein the heel member and the speaker enclosure connect to the body member without adhesive or fasteners.

4. The universal fit audio headphone device of claim 1, wherein the heel member and the body member comprise high coefficient of friction materials to provide a passive support and stabilization system for secure and comfortable placement on the ear, without biasing or pinching means.

5. The universal fit audio headphone device of claim 1, further comprising one or more interchangeable pinna pads for insertion into the body member.

6. The universal fit audio headphone device of claim 1, further comprising an earbud receiver repositionably mounted within the speaker enclosure frame.

7. The universal fit audio headphone device of claim 6, further comprising a bud cap for attachment onto the earbud receiver.

8. The universal fit audio headphone device of claim 1, further comprising an acoustic chamber within the speaker enclosure frame.

9. The universal fit audio headphone device of claim 1, further comprising a speaker within the speaker enclosure frame.

10. The universal fit audio headphone device of claim 1, wherein adjustment of the heel member and the speaker enclosure frame relative to the body member provide universal fit among consumers having ears of differing anatomical structures.

11. An audio headphone device comprising:
a first soft-bodied component;
a second soft-bodied component; and
a coupling between the first soft-bodied component and the second soft-bodied component, said coupling providing at least one degree of freedom of movement between the first soft-bodied component and the second soft-bodied component.

12. The audio headphone device of claim 11, wherein the at least one degree of freedom of movement between the first soft-bodied component and the second soft-bodied component is a rotational degree of freedom.

13. The audio headphone device of claim 11, wherein the coupling provides three degrees of rotational freedom between the first soft-bodied component and the second soft-bodied component.

14. The audio headphone device of claim 11, wherein the first soft-bodied component is a body member for positioning adjacent a pinna portion of an ear of a wearer, and the second soft-bodied component is a heel member.

15. The audio headphone device of claim 11, wherein the first soft-bodied component is a body member for positioning adjacent a pinna portion of an ear of a wearer, and the second soft-bodied component is a speaker enclosure frame.

16. The audio headphone device of claim 11, further comprising a third soft-bodied component, and wherein the first soft-bodied component is a body member for positioning adjacent a pinna portion of an ear of a wearer, the second soft-bodied component is a heel member, and the third soft-bodied component is a speaker enclosure frame.

17. The audio headphone device of claim 16, further comprising an earbud receiver repositionably mounted within the speaker enclosure frame.

18. The audio headphone device of claim 17, further comprising a speaker enclosure assembly comprised of outer and inner shells that are sandwiched against the speaker enclosure frame.

19. The audio headphone device of claim 16, further comprising a plurality of pinna pads for interchangeable engagement within the body member.

20. An audio headphone device comprising:
a body member for positioning adjacent an ear of a wearer, the body member having a pinna pad receiver opening formed therein;
a heel member coupled to the body member by a first jointed coupling allowing at least one degree of rotational freedom therebetween;
a speaker enclosure frame coupled to the body member by a second jointed coupling allowing at least one degree of rotational freedom therebetween;
an earbud receiver repositionably mounted within the speaker enclosure frame; and
at least one interchangeable pinna pad for removable engagement within the pinna pad receiver opening of the body member.
